(19) United States
(12) Patent Application Publication
(10) Pub. No.: US 2010/0094995 A1
(43) Pub. Date: Apr. 15, 2010

(54) Silent Probes in a Communication Network

(75) Inventor: David BARR, San Jose, CA (US)

Correspondence Address: ENTROPIC COMMUNICATIONS, INC., 6290 SEQUENCE DRIVE, SAN DIEGO, CA, 92121, US

(73) Assignee: ENTROPIC COMMUNICATIONS, INC., San Diego, CA (US)

(21) Appl. No.: 12/579,312

(22) Filed: Oct. 14, 2009

Related U.S. Application Data
(60) Provisional application No. 61/105,390, filed on Oct. 14, 2008.
(60) Provisional application No. 61/105,942, filed on Oct. 16, 2008.
(60) Provisional application No. 61/144,061, filed on Jan. 12, 2009.

(51) Int. Cl. G06F 15/173

(52) U.S. Cl. 709/224; 709/223

(57) ABSTRACT

A system, device and process to enable a “silent probe” on a network to facilitate network analysis by nodes within a network. A network node requests the silent probe. During the silent probe, all nodes remain silent so that all nodes can listen, hear, and/or analyze the spectrum of the communications medium.

### RELATED APPLICATIONS

This application claims priority to U.S. Provisional Patent Application Nos. 61/105,390, entitled “Silent Probes for Use in a Home Entertainment Network,” filed Oct. 14, 2008; 61/105,942, entitled “Method and Apparatus for Transmission of Data in a Home Entertainment Network,” filed Oct. 16, 2008; and 61/144,061, entitled “Method and Apparatus for Communication over Coaxial Cable,” filed Jan. 12, 2009.

### FIELD OF DISCLOSURE

The disclosed system and methods relate to communications networking and more specifically to channel assessment probes.

### BACKGROUND

A home network may communicate over coaxial cable wired within a home. In addition to computers, home networks typically include multiple types of subscriber equipment configured to deliver subscriber services through the home network. The subscriber services include delivering multimedia content, such as streaming audio and video, through a home network to subscriber equipment, where it is presented to a user. As the number of available subscriber services increases, so does the number of devices being connected to a home network. The increase in the number of services and devices increases the complexity of coordinating communication between the network nodes as each node may experience different access conditions along its portion of the network.

### SUMMARY

The disclosed method and apparatus provides a system, device and process to enable a “silent probe” on a network to facilitate network analysis by nodes within a network. In accordance with one embodiment, a network node requests the silent probe. In one such embodiment, the network coordinator (NC) receives the request for the silent probe from the network node, and schedules a start time and duration during which all network nodes are required not to transmit data (i.e., a time during which the “silent probe” will occur). In one alternative embodiment, the NC schedule a silent probe without having received a particular request from a network node. A schedule determining when the silent probe will occur is broadcast to all nodes on the network. During the scheduled silent probe, all nodes remain silent so that they can all listen, hear, and/or analyze the spectrum of the communications medium.

### BRIEF DESCRIPTION OF THE DRAWINGS

FIG. 1 is a block diagram of a communication system.

FIG. 2 is a block diagram of a network node in accordance with the communication system illustrated in FIG. 1.

FIG. 3 illustrates a flow chart of a silent probe process performed at a network node.

FIG. 4 depicts a flow chart of a silent probe process performed at a network coordinator.

### DETAILED DESCRIPTION

The system, device and process described herein all facilitate network analysis by nodes within a network. In one aspect, a network node requests a clean channel assessment probe or “silent probe.” During a silent probe, all nodes remain silent so that each node on the network can listen, hear, and/or analyze the spectrum of the communications medium.

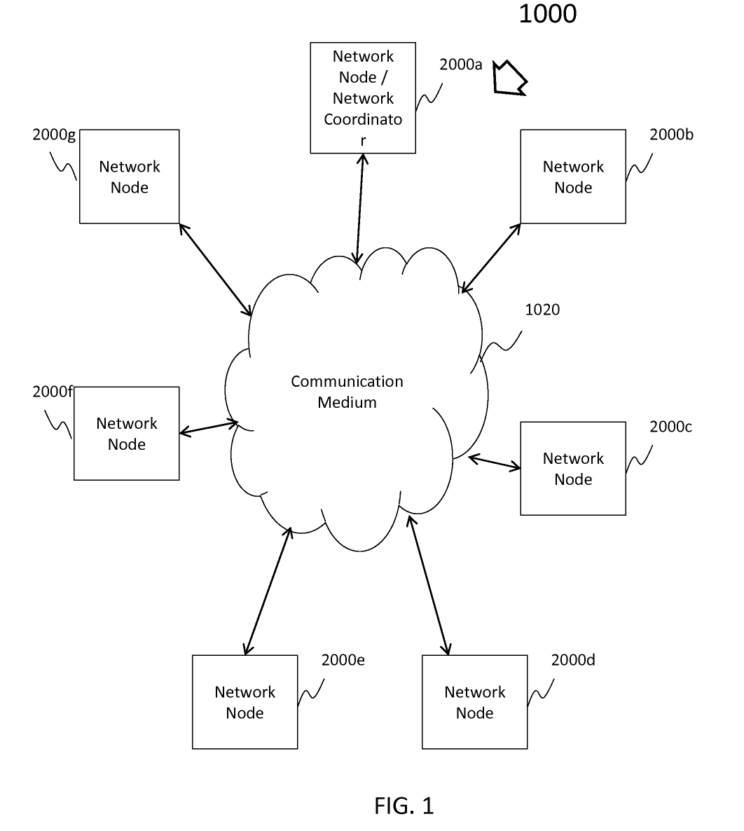

FIG. 1 illustrates one example of a communication system 1000 including a plurality of network nodes 2000a-g (collectively referred to as “network nodes 2000”) each configured to communicate with the other nodes through a communication medium 1020. Examples of the communication medium 1020 include, but are not limited to, coaxial cable, fiber optic cable, a wireless transmission medium, an Ethernet connection, or the like. Throughout this discussion, the term “communication medium” has the same meaning as “network medium.” In one embodiment, communication medium 1020 is a coaxial cable network.

The network nodes 2000 may be devices of a home entertainment system such as, for example, set top boxes (STBs), television (TVs), computers, DVD or Blu-ray players/recorders, gaming consoles, or the like, each coupled to each other via the communication medium 1020.

In some embodiments, communication system 1000 may be a Multimedia over Coax Alliance (MoCA) network. The MoCA architecture dynamically assigns a network node 2000 as a “Network Coordinator” (NC), in order to coordinate the operation of the nodes of the network. For the sake of this example, assume network node 2000a is designated as and performs the functions of the NC. Only the NC 2000a is able to schedule traffic for all other nodes 2000b-g in the network and form a full mesh network architecture between any device and its peers.

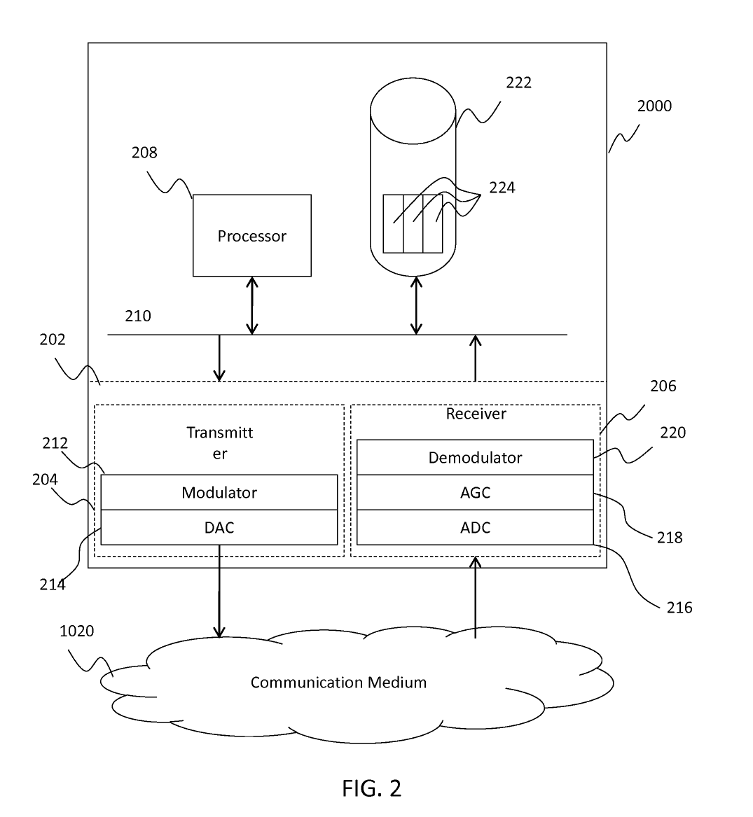

Moving on to FIG. 2, in one embodiment, each of the network nodes 2000 includes a physical interface 202 including a transmitter 204 and a receiver 206 in signal communication with a processor 208 through a data bus 210. In one embodiment, the transmitter 204 includes a modulator 212 for modulating data according to a quadrature amplitude modulation (QAM) scheme such as, for example, 8-QAM, 16-QAM, 32-QAM, 64-QAM, 128-QAM, or 256-QAM, and a digital-to-analog converter (DAC) 214 for transmitting modulated signals to other network nodes 200 through the communication medium 102.

In one such embodiment, the receiver 206 includes an analog-to-digital converter (ADC) 216 for converting an analog modulated signal received from another network node 200 into a digital signal. Receiver 206 also includes an automatic gain control (AGC) circuit 218 for adjusting the gain of the receiver 206 to properly receive the incoming signal and a demodulator 220 for demodulating the received signal. One skilled in the art will understand that in accordance with an alternative embodiment, the network nodes 2000 include additional circuitry and functional elements not described herein.

In one embodiment, the processor 208 is any central processing unit (CPU), microprocessor, micro-controller, or computational device or circuit for executing instructions. As shown in FIG. 2, the processor 208 is in signal communication with a computer readable storage medium 222 through data bus 210. In one embodiment, the computer readable storage medium includes a random access memory (RAM) and/or a more persistent memory such as a read only memory (ROM). Examples of RAM include, but are not limited to, static random-access memory (SRAM), or dynamic random-access memory (DRAM). In one embodiment, the ROM is implemented as a programmable read-only memory (PROM), an erasable programmable read-only memory (EPROM), an electrically erasable programmable read-only memory (EEPROM), or the like as will be understood by one skilled in the art.

In one embodiment, one or more look-up tables (LUTs) 224 are stored in the computer readable storage medium 222. In one such embodiment, these LUTs 224 include a plurality of APHYM values, each value being associated with an aggregate received power level (ARPL) value and/or a received signal strength indicator (RSSI), which may be based on the signal-to-noise ratio (SNR) of each subcarrier of an Orthogonal Frequency Division Multiplexing (OFDM) probe.

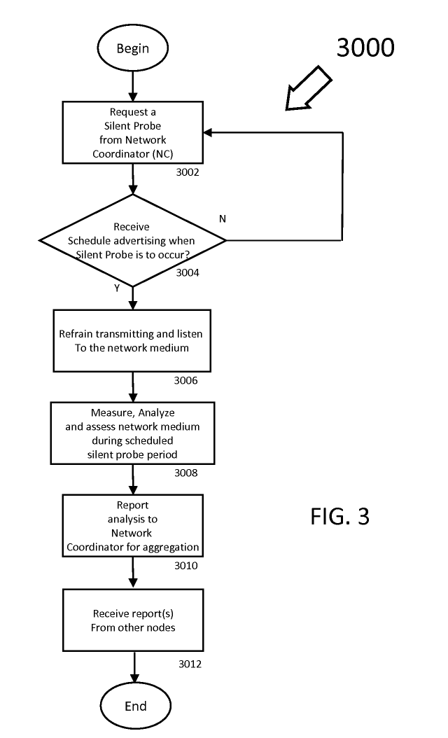

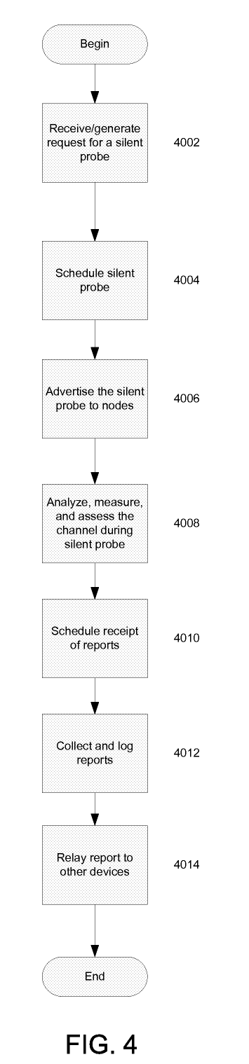

We now turn to the processes described in FIGS. 3 and 4. It is understood by those known in the art that the processes described below may be embodied in hardware, firmware, software embedded in a computer-readable medium or any combination of these.

FIG. 4 depicts a flow chart of one embodiment of the process 4000 for generating and using a clean channel assessment probe (“silent probe”) performed at a NC 2000a. In accordance with the embodiment of FIG. 4, the process 4000 is initially requested by any node 2000 in the network, including a node acting as a NC 2000a. However, in one alternative embodiment, the process may be initiated by the NC on the NC's own initiative.

At block 4002, NC 2000a receives the silent probe request. NC 2000a schedules a silent time on the communication medium when all nodes remain silent (i.e. a silent probe during which all nodes are forbidden to transmit information), block 4004. This schedule is advertised to all of the nodes of the network.

The silent time offers all nodes the opportunity to listen to, measure, analyze and/or assess the communication medium. In accordance with one embodiment of the disclosed method and apparatus, any and all nodes 2000 may schedule/use the silent time to assess conditions on the current channel, assess conditions on a prospective alternate channel, and/or search, detect and/or characterize existing signals and services on the communications medium 1020. For example, if no services are being transmitted on the communication medium 1020, a node 2000 can measure the power and perform spectral analysis to characterize the communication medium 1020 noise floor and make other assessments of the channel. Such a spectral analysis augments other active (i.e. non-silent) channel assessment probes. Furthermore, in another embodiment, when devices or services are operating on other channels, observations can be used to measure the power and spectral shape of interference from those other channels on the channel of interest. Furthermore, if one or more nodes wish to assess whether to move to another channel, the conditions of that prospective alternative channel can be measured without interference from the current channel.

Once the NC 2000a schedules a silent probe on the communication medium 1020, the NC 2000a advertises the start time and duration of the silent probe to all network nodes 2000, informing the nodes 2000 about the silent time, block 4006. The broadcast message contains a scheduled and advertised silent probe on the communication medium 1020. In some embodiments, the silent probe is a message in which the contents are a null payload, with the silent probe duration specified by the number of symbols in the payload. In one embodiment, the NC advertises the silent probe's schedule in a media access plan (MAP) message.

In accordance with one embodiment, at block 4008, NC 2000a listens and measures, analyzes, and assesses the communication medium 1020 during the scheduled silent probe. Alternatively, the NC 2000a does not do analysis during the silent probe, but rather relies upon the analysis of the other nodes for any information regarding the nature of the communication medium 1020.

In one embodiment, after the silent probe is complete, NC 2000a schedules receipt of analysis reports from other network nodes 2000 compiled during the silent probe, block 4010. The NC 2000a collects and logs the analysis reports, block 4012. In some embodiments, the reports may be logged on to the computer readable storage medium 222. These reports can then be made available to other devices, services, people to facilitate remote management of the network, as shown in 4014. The reports from network nodes 2000 are distributed across the communication medium 1020. Accordingly, each node 2000 measures its own unique local environment, and provides the opportunity for the NC 2000a (or any other node receiving the reports) to analyze the entire communication medium 1020 as a whole. Reports also enable statistical analysis of multiple silent probes taken over a period of time. Silent probes may be scheduled and performed periodically and reports may be aggregated over long periods of time, allowing network administrators to detect and diagnose a myriad of network problems. For example, aggregated reports may aid in detection of intermittent or transient interference, allowing the network to adapt to intermittent interferers. Accordingly, the each network device can make determinations to adapt their bit-loading or the bit-loading of other nodes, etc. based on the reports to keep the network robust.

An equivalent process occurs at various network nodes 2000. FIG. 3 illustrates a flow chart of a process 3000 performed at a network node 2000. Process 3000 may be initiated by any node 2000 in the network, including a node acting as an NC 2000a. In the particular embodiment shown in FIG. 3, at block 3002, network node 2000 transmits a request for a silent probe to an NC 2000a, and waits for the NC 2000a to schedule the silent probe.

If a silent probe is scheduled and advertised by the NC 2000a, as determined at decision block 3004, flow continues at block 3006. Otherwise, flow returns to block 3002.

At block 3006, the NC 2000a determines the start time and duration of the silent probe (which in one embodiment is determined based upon information received from the NC 2000a in a MAP message). At the start time and duration specified by the NC 2000a, the network node 2000 does not transmit. At block 3008, during the silent probe, the network node 2000 measures, analyzes, and assesses the communications medium 1020. As described above, the network node 2000 may perform various forms of analysis of the communications medium 1020. In block 3010, this analysis is then reported to the NC 2000a. In one embodiment, the node receives reports from other nodes, as shown in block 3012. In one such embodiment, the NC 2000a aggregates the report with other reports received from other nodes. The aggregated report is then relayed to one or more other nodes of the network. In an alternative embodiment, the report is sent alone or in aggregation with other reports that have been received by the node 2000.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention. Delimiters used in the claims—such as ‘(a)’ and ‘(i)’—should not be taken as imputing any order to the claims, but rather are provided only to serve as visual cues to add in the parsing of the claims and as identifiers in the event that a particular portion of the claim is to be later referenced.

What is claimed is:

1. A method, comprising:
scheduling a silent probe as a time and duration in which network nodes may not transmit; and
communicating the schedule to all nodes on the network.

2. The method of claim 1, further comprising:
receiving analysis reports from network nodes, the reports having been compiled during the silent probe and containing analysis of the communication medium.

3. The method of claim 1, further wherein the scheduling of the silent probe is done in response to a request from at least one network node.

4. The method of claim 1, wherein the schedule specifies the duration of the silent probe as a number of symbols.

5. The method of claim 1, wherein the schedule for the silent probe is communicated in a MAP Message.

6. The method of claim 2, wherein the analysis reports contain information attained by performing spectral analysis during the silent probe.

7. The method of claim 2, further comprising:
logging the analysis reports on to a computer readable storage medium.

8. A network coordinator, comprising:
a receiver configured to receive a request for a silent probe from a node on a network;
a processor coupled to the receiver, the processor configured to schedule the silent probe at a time and duration, during which the nodes may not transmit; and
a transmitter, coupled to the processor, configured to broadcast to all nodes on the network the schedule for the silent probe.

9. The network coordinator of claim 8, wherein the receiver is further configured to receive analysis reports about a communication medium, such reports being compiled from measurement made during the silent probe from at least one network node.

10. The network coordinator of claim 8, wherein the processor is further configured to analyze the network during the silent probe.

11. The network coordinator of claim 8, wherein the schedule for the silent probe specifies the duration of the silent probe as a number of symbols.

12. The network node of claim 8, wherein the schedule for the silent probe is included within a MAP message.

13. The network coordinator of claim 10, wherein the analysis is a spectral analysis.

14. The network node of claim 9, further comprising:
a computer readable storage medium, coupled to the processor, configured to log the analysis reports.

15. A computer readable storage medium encoded with data and instructions which, when executed by a device, cause the device to:
receive from a node on a network, a request for a silent probe;
schedule the silent probe at a start time and duration during which network nodes coupled to the device over the network may not transmit data; and
communicate to all nodes on the network the schedule for the silent probe.

16. The computer readable storage medium of claim 15, when executed by the device further causes the device to:
receive analysis reports about the silent probe from at least one network node.

17. The computer readable storage medium of claim 17 which, when the data and instructions are executed by the device, further causes the device to:
analyze the network during the silent probe.

18. The computer readable storage medium of claim 15, wherein the schedule for the silent probe specifies the duration of the silent probe as a number of symbols.

19. The computer readable storage medium of claim 15, wherein the schedule for the silent probe is included in a MAP message.

20. The computer readable storage medium of claim 17, wherein the analysis of the network is a spectral analysis.
